(19) United States
(12) Patent Application Publication
(10) Pub. No.: US 2020/0358331 A1
(43) Pub. Date: Nov. 12, 2020

(54) ELECTRICAL CONNECTION KIT, ASSOCIATED STATOR AND ROTATING ELECTRICAL MACHINE

(71) Applicant: GE ENERGY POWER CONVERSION TECHNOLOGY LIMITED, WARWICKSHIRE (GB)

(72) Inventor: Pierre Guillon, Champigneulles (FR)

(73) Assignee: GE ENERGY POWER CONVERSION TECHNOLOGY LIMITED, WARWICKSHIRE (GB)

(21) Appl. No.: 16/872,224

(22) Filed: May 11, 2020

(30) Foreign Application Priority Data
May 10, 2019 (EP) 19305607.4

(51) Int. Cl. H02K 5/22; H01R 39/02; H02K 1/12; H02K 3/04

(52) U.S. Cl. CPC H02K 5/225; H01R 39/02; H01R 2201/10; H02K 3/04; H02K 1/12

(57) ABSTRACT

The electrical connection kit (16) for a multipole polyphase stator of a rotating electrical machine comprises a plurality of conductive elements (18, 19, 20, 21) that are superposed and electrically insulated so as to form an electrical connection circuit for each pole of each of the phases.

The kit is intended to be grafted on one of the sides of the stator.

This invention relates to rotating electrical machines and relates more particularly to electrical connections of stator coils and to electrical connections between groups of stator coils.

A rotating electrical machine is generally powered by a plurality of phases each comprising a plurality of poles, each phase comprising an equal number of poles distributed uniformly over the circular periphery of the stator of said machine.

In general, each pole comprises several coils connected to one another in series, the coils being inserted into notches formed by stator teeth produced in the magnetic yoke of the stator.

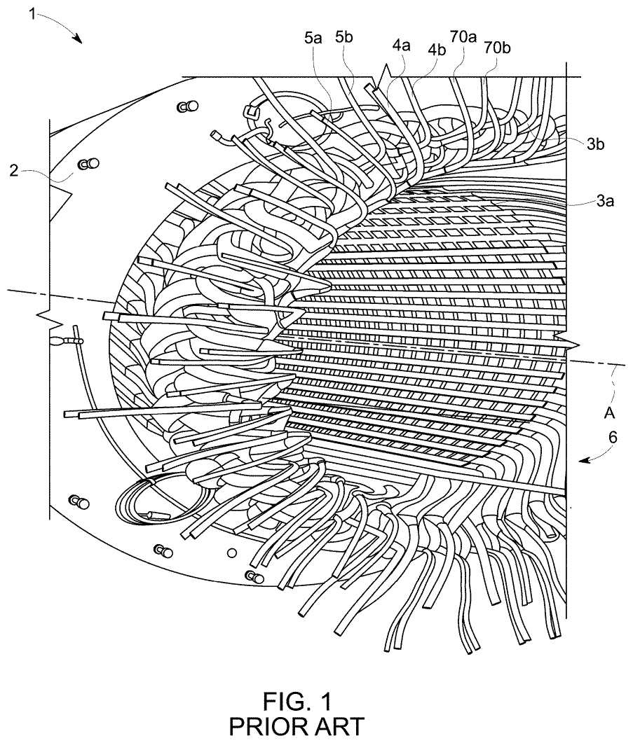

FIG. 1 depicts a coiled stator 1 according to the prior art.

The stator 1 comprises a magnetic yoke 2 wherein coils 3, 4, 5, 70 are inserted distributed regularly over the inner periphery of the yoke.

The stator further comprises a central axis A.

The coils 3, 4, 5, 70 each comprise a top tail 3a, 4a, 5a, 70a and a bottom tail 3b, 4b, 5b, 70b intended to be connected in series with an adjacent coil or to be connected to other poles of the phase in question.

The bottom tails 3b, 4b, 5b, 70b are arranged between an external periphery of the stator 1 and the central axis A, the top tails 3a, 4a, 5a, 70a being arranged between the bottom tails and the central axis A.

The top and bottom tails are located on the same open side 6 of the stator 1.

FIG. 2 shows a partial view of the stator 1 wherein the coils 3, 4, 5 and 70 are connected to one another in series so as to form a pole.

The bottom tail 3b and the top tail 70a are intended to power the pole.

The bottom tail 70b is connected to the top tail 5a, the bottom tail 5b is connected to the top tail 4a and the bottom tail 4b is connected to the top tail 3a.

The top and bottom tails are connected to one another by brazing.

Putty is applied to each braze, then the braze and the bare parts of the tails are covered with an electrical insulator 7.

The putty prevents air from being trapped between the insulator and the tails to avoid the formation of an electric arc (partial discharges).

When all the poles of each of the phases have been formed, the poles of each of the phases are connected so as to form said phase by repeating the operations of brazing, putty applications and electrical insulation.

However, the steps of series connection of the coils and connection of the poles are carried out one after the other increasing the time taken to manufacture the stator 1.

It is therefore proposed to overcome all or some of the drawbacks of producing stators according to the prior art, in particular by reducing the time taken to manufacture the stator.

In light of the foregoing, an electrical connection kit for a multipole polyphase stator of a rotating electrical machine is proposed, the kit comprising a plurality of conductive elements that are superposed and electrically insulated so as to form an electrical connection circuit for each pole of each of the phases.

The kit is intended to be grafted on one side of the stator.

According to one feature, each conductive element comprises connecting ends intended to be connected to at least one pole.

According to another aspect, a multipole polyphase stator for rotating electrical machine is proposed, comprising an electrical connection kit as defined above, and comprising coils each inserted into a notch of the magnetic yoke of the stator, each phase comprising the same number of coils connected with one another in series so as to form a pole, the electrical connection kit being connected to each pole of each of the phases.

According to one feature, the connection kit and the junctions between the coils are arranged on a same side of the stator.

Preferably, each pole comprises the same number of coils, the coils comprising an input coil, at least one series-connection coil and an output coil such that the junctions between the coils open out on a second side of the stator, the input coils and output coils further being connected to the connection kit grafted on the first side of the stator.

Advantageously, the input coil comprises two bottom tails each arranged on a different side of the stator, the series-connection coil comprises, on the second side of the stator, a top tail and a bottom tail, and the output coil comprises two top tails each arranged on a different side of the stator, the coils being electrically connected to one another such that a first bottom tail of the input coil is connected to the top tail of the series-connection coil and the bottom tail of the series-connection coil is connected to a first top tail of the output coil, the junctions between the coils opening out on the second side of the stator, the second bottom tails and top tails of the input coils and output coils being connected to the connection kit grafted on the first side of the stator.

According to still another aspect, a multipole polyphase stator for rotating electrical machine is proposed, comprising coils each inserted into a notch of the magnetic yoke of the stator, each phase comprising a same number of coils connected with one another in series so as to form a pole.

The junctions between the coils are arranged on a second side of the stator, and the connections between the poles of each phase are arranged on the first side of the stator.

According to one feature, each pole comprises an input coil, at least one series-connection coil and an output coil, the input coil comprising two bottom tails each arranged on a different side of the stator, the series-connection coil comprising, on the second side of the stator, a top tail and a bottom tail, and the output coil comprising two top tails each arranged on a different side of the stator, the coils being electrically connected to one another such that a first bottom tail of the input coil is connected to the top tail of the series-connection coil and the bottom tail of the series-connection coil is connected to a first top tail of the output coil, the second bottom tails and top tails of the input coils and output coils being connected to the poles of said phase.

Preferably, the stator comprises an electrical connection kit, the kit comprising a plurality of conductive elements that are superposed and electrically insulated so as to form an electrical connection circuit for each pole of each of the phases, the kit being grafted on the first side of the stator.

Advantageously, each conductive element comprises connecting ends connected to at least one pole.

According to another aspect, a rotating electrical machine comprising a stator as defined above is proposed.

Other features and advantages of the invention will become apparent upon reading the following description of embodiments of the invention, given solely as nonlimiting examples and referring to the drawings in which:

FIGS. 1 and 2, which have already been mentioned, show a stator according to the prior art;

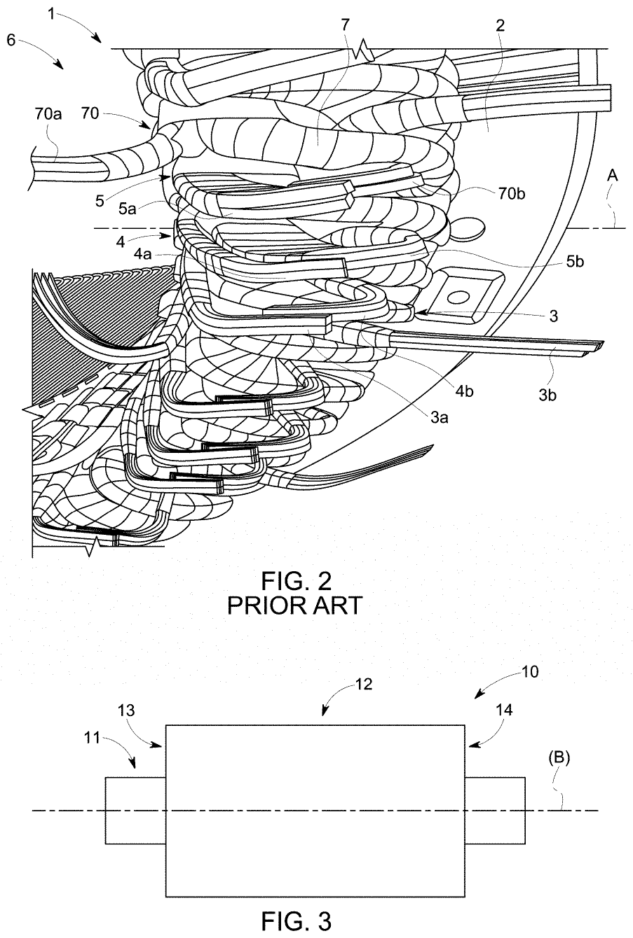

FIG. 3 shows an embodiment of a multipole polyphase rotating electrical machine according to the invention;

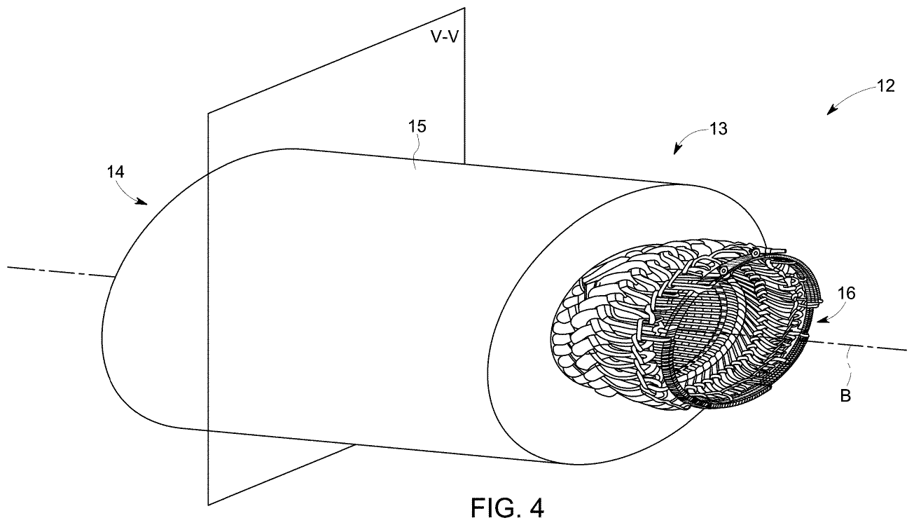

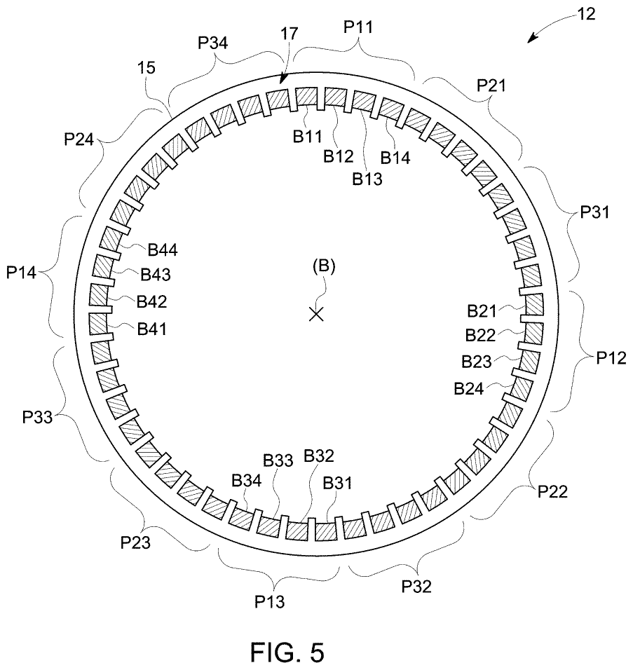

FIGS. 4 and 5 show a first embodiment of the stator according to the invention;

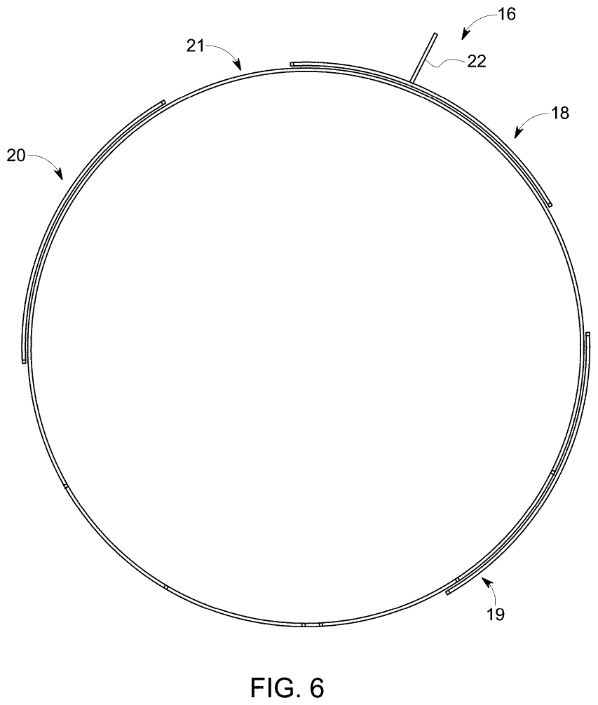

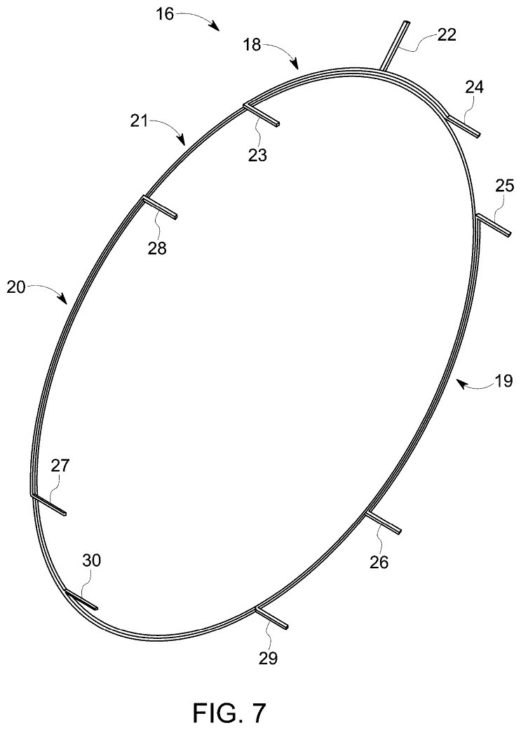

FIGS. 6 and 7 show an exemplary embodiment of the connection kit;

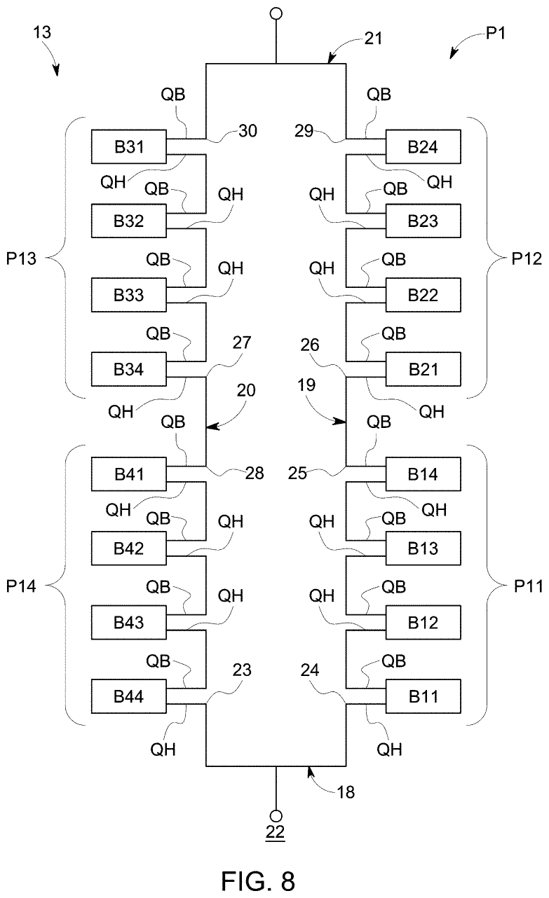

FIG. 8 shows an example of connection of the poles of the phase to the connection kit;

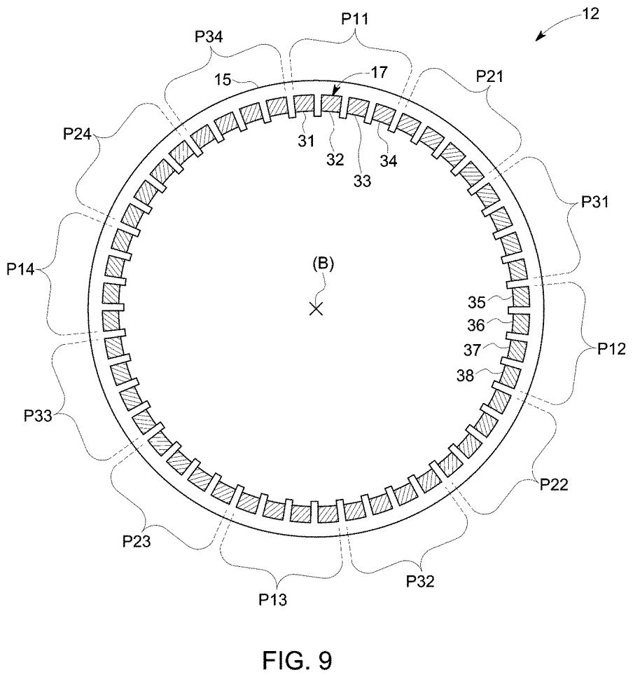

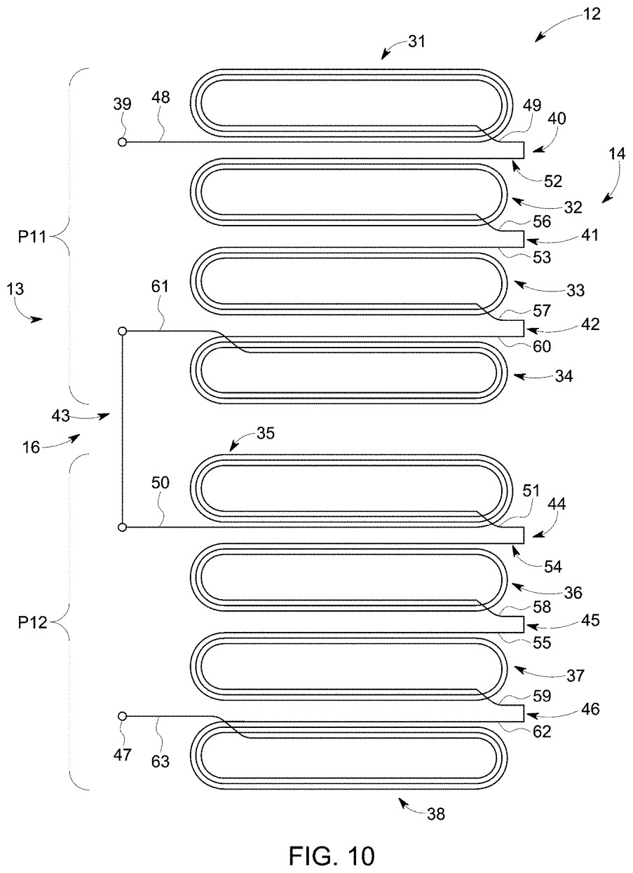

FIGS. 9 and 10 show a second embodiment of the stator according to the invention; and

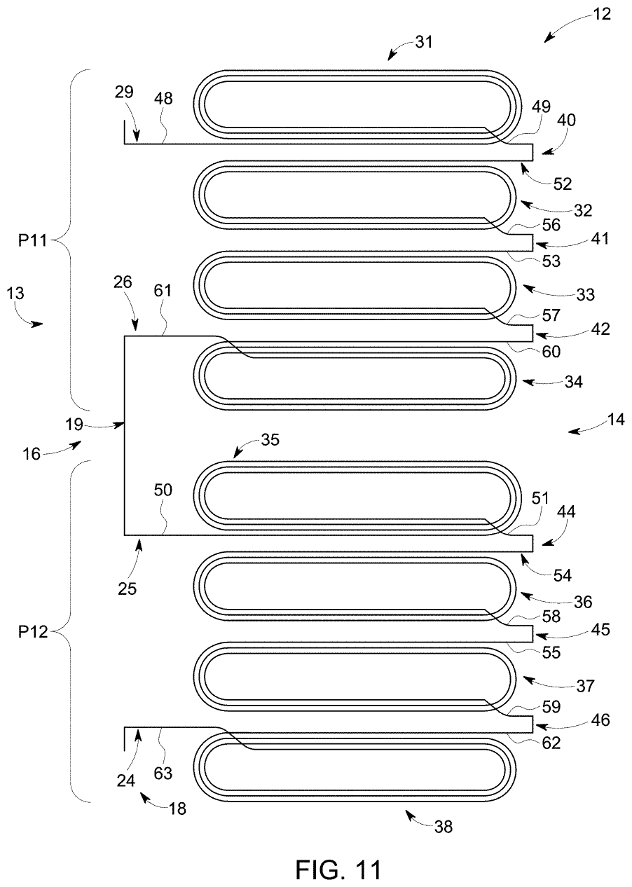

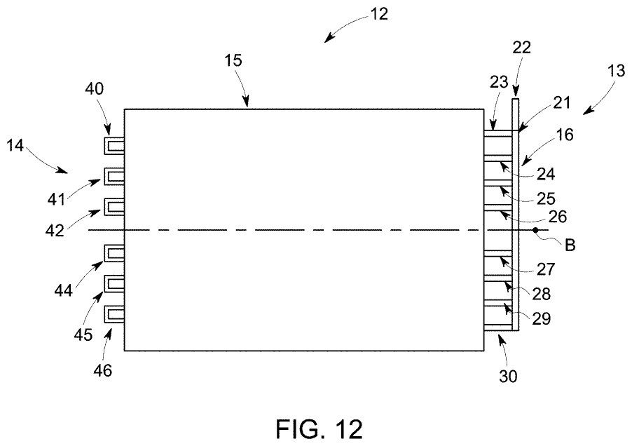

FIGS. 11 and 12 show a third embodiment of the stator according to the invention.

Reference will be made to FIG. 3 which shows an embodiment of a multipole polyphase rotating electrical machine 10 comprising a rotor 11 inserted in a stator 12 comprising a central axis B, a first open side 13 and a second open side 14

The rotating electrical machine 10 may for example be of the synchronous, asynchronous or DC type, and the phases of the stator 12 are for example single or double star-coupled to internal or output neutral, single or double delta-coupled, or Dahlander-coupled.

The rotating electrical machine 10 can operate in generator mode in order to produce electrical power from mechanical power or in motor mode in order to produce mechanical power from electrical power.

Hereinafter, the rotating electrical machine 10 is for example of the three-phase type and the three-phase stator 12 comprises for example two pairs of poles per phase, each pole comprising four coils, the phases being for example star-connected.

Of course, the stator 12 may comprise a different number of pairs of poles comprising a different number of coils, the phases being connected according to configurations other than a star-type configuration.

Reference is made to FIGS. 4 and 5 which show a sectional view and an electrical diagram of a first embodiment of the stator 12.

The stator 12 comprises a magnetic yoke 15 and an electrical connection kit 16 forming an electrical connection circuit for each pole of each of the three phases of the stator 12.

Each phase comprises a same number of pair of poles and each pole comprises the same number of coils connected in series, the poles being of identical formation.

Each phase of the stator 12 comprises sixteen coils grouped together into two pairs of poles, each pole comprising four identical coils.

The coils of each pole are connected in series, two poles being connected in series by links between groups and two groups of two poles being connected in parallel.

Reference is more particularly made to FIG. 5 which shows a section along the direction V-V of the stator 12.

A first phase P1 comprises four poles P11, P12, P13 and P14, a second phase P2 comprises four poles P21, P22, P23 and P24 and a third phase P3 comprises four poles P31, P32, P33 and P34.

The coils of phases P1, P2 and P3 are identical.

Since the phases are formed identically, for the sake of simplicity only phase P1 is described in detail hereinafter.

Poles P11, P12, P13 and P14 of phase P1 each comprise, respectively, four identical coils B11, B12, B13 and B14, B21, B22, B23 and B24, B31, B32, B33 and B34, B41, B42, B43 and B44 each inserted into a notch 17 of the magnetic yoke 15.

Each pole P11, P12, P13 and P14 comprises an input coil B11, B21, B31 and B41, and an output coil B14, B24, B34 and B44

Each coil comprises a top tail TT and a bottom tail BT.

The top tails TT and bottom tails BT of the input coils and output coils of the same pole, connected to another pole, are arranged on the first open side 13 of the stator 12.

The connection kit 16 is grafted on the first side 13 of the stator 12 and is connected to each pole of each of phases P1, P2 and P3, the connections between the connection kit 16 and the poles being located on the first side 13. The junctions for series connecting the coils of each pole P11, P12, P13 and P14 are located on the first side 13.

As a variant, the top tails TT and bottom tails BT of the input coils and output coils of the same pole, connected to another pole, are arranged on the second open side 14 of the stator 12, the connection kit 16 being grafted on the second side 14 of the stator 12, and the connections between the connection kit 16 and the poles being located on the second side 14. The junctions for series connecting the coils of each pole P11, P12, P13 and P14 are located on the second side 14.

Reference is made to FIGS. 6 and 7 which show an exemplary embodiment of the connection kit 16.

In order to simplify FIGS. 6 and 7, only the connections of poles P11, P12, P13 and P14 of phase P1 are depicted.

The connection kit 16 comprises a plurality of conductive elements 18, 19, 20 and 21 that are superposed and electrically insulated (the electrical insulator is not shown) so as to form an electrical connection circuit for each pole P11, P12, P13 and P14 of phase P1.

Conductive element 21 forms the neutral and conductive elements 18, 19 and 20 connect the poles to one another.

Conductive element 18 comprises an end 22 intended to power phase P1.

Conductive elements 18, 19, 20 and 21 comprise connecting ends 23, 24, 25, 26, 27, 28, 29 and 30 connected to the poles.

Conductive elements 18, 19 and 20 comprising the connecting ends are for example made of copper and obtained for example by in-situ folding or by flat folding of copper bars.

The end 22 for powering phase P1 is attached to conductive element 21, for example by brazing.

The connection kit 16 forms for example a crown, the conductive elements being held together by bracing.

The connection kit 16 is produced without brazing or welding such that no protruding element damages the electrical insulators covering the conductive elements.

FIG. 8 shows an example of connection of the poles of phase P1 to the connection kit 16.

The coils of the same pole are connected to one another in series such that a top tail TT of one coil is connected to a bottom tail BT of an adjacent coil.

The top tails TT of coils B11 and B44 of poles P11 and P14 are connected to conductive element 18 via connecting ends 24 and 23.

The bottom tails BT of coils B14 and B41 are connected, respectively, to the top tails TT of coils B21 and B34 of poles P12 and P13 via conductive elements 19 and 20, coils B14 and B21 being connected via connecting ends 25 and 26, and coils B41 and B34 being connected via connecting ends 27 and 28.

The bottom tails BT of coils B24 and B31 are connected to conductive element 21 via connecting ends 29 and 30.

The coils are connected to the connecting ends of the conductive elements for example by brazing, application of putty and then electrical insulation of the bare parts and the brazes.

According to another embodiment, the connections may be made by inverting the top tails TT and the bottom tails BT of the coils connected to the kit 16.

The connection kit 16 may be produced independently of the production of the coiled stator comprising the magnetic yoke 15.

The connection kit 16 may for example be produced in advance in order to be stored before the production of the coiled stator.

Moreover, only the connections between the coils and the connecting ends of the connection kit are produced on a production line, allowing it to reduce the time the stator spends on said production line, thus reducing the overall time taken to manufacture the stator.

Reference is made to FIGS. 9 and 10 which show a sectional view and a schematic view of the connection of coils from a second embodiment of the stator 12.

The stator 12 comprises the first phase P1 comprising the four poles P11, P12, P13 and P14, the second phase P2 comprising four poles P21, P22, P23 and P24 and the third phase P3 comprising the four poles P31, P32, P33 and P34.

The poles of each phase are connected in series, each pole comprising the same number of identical coils.

The coils of phases P1, P2 and P3 are identical.

Since the phases and the poles are formed identically, for the sake of simplicity only poles P11 and P12 of phase P1 are described in detail hereinafter.

Reference is more particularly made to FIG. 10 which shows the electrical junctions of poles P11 and P12, carcass 15 of the stator 12 removed.

Each pole P11, P12 comprises an input coil 31, 35, two series-connection coils 32, 33 and 36, 37 and an output coil 34 and 38.

Input coil 31 of pole P11 is connected on one side for example to electrical power supply means (not shown) via a first connection 39 and, on the other side, connected to the first series-connection coil 32 by a first junction 40.

The first series-connection coil 32 is connected by a second junction 41 to the second series-connection coil 33.

The second series-connection coil 33 is connected by a third junction 42 to the output coil 34.

Output coil 34 is connected to input coil 35 of pole P12 via a second connection 43.

In addition, input coil 35 of pole P12 is connected to the first series-connection coil 36 by a fourth junction 44.

The first series-connection coil 36 is connected by a fifth junction 45 to the second series-connection coil 37.

The second series-connection coil 37 is connected by a sixth junction 46 to output coil 38.

Output coil 38 is connected via a third connection 47 to pole P13.

Junctions 40, 41, 42, 44, 45 and 46 between coils 31, 32, 33, 34, 35, 36, 37 and 38 are arranged on the second side 14 of the stator 12, and connections 39, 43 and 47 between the poles are arranged on the first side 13 of the stator 12.

According to another embodiment, each pole may comprise a single series-connection coil or more than two series-connection coils, the coils being connected in series such that the junctions between the coils are arranged on a first side of the stator and the connections between each pole are arranged on a second side of the stator.

According to yet another embodiment, each pole may comprise a single coil of the input coil or output coil type, the coil being connected such that the junctions between the coils are arranged on a first side of the stator and the connections between each pole are arranged on a second side of the stator.

Since the junctions are arranged on the second side 14 of the stator, opposite the first side 13 of the stator comprising the connections, the operations of brazing, putty application and electrical insulation of the junctions and connections may be carried out simultaneously, reducing the time taken to manufacture the stator 12.

Of course, the junctions and connections may be realized by another process.

Input and output coils 31, 34, 35 and 38 comprise a half-turn more or less than series-connection coils 32, 33, 36 and 37 so as to include, respectively, two bottom tails and two top tails.

Each input coil 31, 35 comprises two bottom tails 48, 49, 50, 51 arranged one 49, 51 on the second side 14 of the stator 12 and the other 48, 50 on the first side 13 of the stator 12, each series-connection coil 32, 33, 36 and 37 comprises, on the second side 14 of the stator, a top tail 52, 53, 54 and 55 and a bottom tail 56, 57, 58 and 59, and each output coil 34, 38 comprises two top tails 60, 61, 62 and 63 arranged one 60, 62 on the second side of the stator 14 and the other 61, 63 on the first side 13 of the stator 12.

The first bottom tail 49, 51 of the input coil 31, 35 is connected to the top tail 52, 54 of the first series-connection coil 32, 36 via the first junction 40 and the fourth junction 44, the bottom tail 56, 58 of the first series-connection coil 32, 36 is connected to the first top tail 53, 55 of the second series-connection coil 33, 37 via the second junction 41 and the fifth junction 45, the second top tail 57, 59 of the second series-connection coil 33, 37 is connected to the first top tail 60, 62 of the output coil 34, 38 via the third junction 42 and the sixth junction 46.

The second bottom tail 48 of the input coil 31 is connected to the first connection 39, the second top tail 61 of the output coil 34 and the second bottom tail 50 of the input coil 35 are connected to the second connection 43, and the second top tail 63 of the output coil 38 is connected to the third connection 47.

FIGS. 11 and 12 show a schematic view of the connection of coils and a view of a third embodiment of the stator 12.

This embodiment differs from the second embodiment shown in FIGS. 9 and 10 in that the poles are connected to the connection kit 16.

The second bottom tail 48 of the input coil 31 is connected to the connection 29 of the connection kit 16, the second top tail 61 of the output coil 34 and the second bottom tail 50 of the input coil 35 are connected to the connecting ends 25 and 26 of the conductive element 19 of the connection kit 16, and the second top tail 63 of the output coil 38 is connected to the connecting end 24 of the connection kit 16.

Since the connection kit 16 can be produced independently of the production of the stator comprising the magnetic yoke 15, and the junctions are arranged on the second side 14 of the stator opposite the first side 13 of the stator comprising the connections, the operations of brazing, putty application and electrical insulation of the junctions and connections may be carried out simultaneously, reducing the time taken to manufacture the stator 12. The duration of the connection operations is shortened compared to the connection operations carried out in the second embodiment.

This embodiment of the stator 12 allows to yet further reduce the time taken to manufacture the stator compared to the previous embodiments.

1. A kit for electrical connection for a multipole polyphase stator of a rotating electrical machine, the kit comprising a plurality of conductive elements that are superposed and electrically insulated so as to form an electrical connection circuit for each pole of each of the phases, characterized in that the kit is intended to be grafted on one side of the stator.

2. The kit according to claim 1, wherein each conductive element comprises connecting ends intended to be connected to at least one pole.

3. A multipole polyphase stator for rotating electrical machine, comprising an electrical connection kit according to claim 1, and comprising coils each inserted into a notch of the magnetic yoke of the stator, each phase comprising the same number of coils connected to one another in series so as to form a pole, the electrical connection kit being connected to each pole of each of the phases.

4. The stator according to claim 3, wherein the connection kit, and the junctions between the coils are arranged on the same side of the stator.

5. The stator according to claim 3, wherein each pole comprises the same number of coils, the coils comprising an input coil, at least one series-connection coil and an output coil such that the junctions between the coils open out on a second side of the stator, the input coils and output coils further being connected to the connection kit grafted on the first side of the stator.

6. The stator according to claim 5, wherein the input coil comprises two bottom tails each arranged on a different side of the stator, the series-connection coil comprises, on the second side of the stator, a top tail and a bottom tail, and the output coil comprises two top tails each arranged on a different side of the stator, the coils being electrically connected to one another such that a first bottom tail of the input coil is connected to the top tail of the series-connection coil and the bottom tail of the series-connection coil is connected to a first top tail of the output coil, the junctions between the coils opening out on the second side of the stator, the second bottom tails and top tails of the input coils and output coils being connected to the connection kit grafted on the first side of the stator.

7. A multipole polyphase stator for rotating electrical machine, comprising coils each inserted into a notch of the magnetic yoke of the stator, each phase comprising a same number of coils connected to one another in series so as to form a pole, characterized in that the junctions between the coils are arranged on a second side of the stator, and the connections between the poles of each phase are arranged on the first side of the stator.

8. The stator according to claim 7, wherein each pole comprises an input coil, at least one series-connection coil and an output coil, the input coil comprising two bottom tails each arranged on a different side of the stator, the series-connection coil comprising, on the second side of the stator, a top tail and a bottom tail, and the output coil comprising two top tails each arranged on a different side of the stator, the coils being electrically connected to one another such that a first bottom tail of the input coil is connected to the top tail of the series-connection coil and the bottom tail of the series-connection coil is connected to a first top tail of the output coil, the second bottom tails and top tails of the input coils and output coils being connected to the poles of said phase.

9. The stator according to claim 8, comprising an electrical connection kit, the kit comprising a plurality of conductive elements that are superposed and electrically insulated so as to form an electrical connection circuit for each pole of each of the phases, the kit being grafted on the first side of the stator.

10. The stator according to claim 9, wherein each conductive element comprises connecting ends connected to at least one pole.

11. A rotating electrical machine comprising a stator according to claim 3.
